(19) United States
(12) Patent Application Publication
(10) Pub. No.: US 2022/0318659 A1
(43) Pub. Date: Oct. 6, 2022

(54) MACHINE LEARNING OF ABNORMAL USER BEHAVIOR DATA NETWORKS ACROSS DIFFERENT TIME ZONES

(71) Applicant: Fortinet, Inc., Sunnyvale, CA (US)

(72) Inventors: Chenchen Zhou, Sunnyvale, CA (US); Dancheng Sun, Sunnyvale, CA (US)

(21) Appl. No.: 17/219,409

(22) Filed: Mar. 31, 2021

(51) Int. Cl. G06N 7/00; G06F 16/21; G06N 20/00

(52) U.S. Cl. CPC G06N 7/005; G06F 16/212; G06N 20/00

(57) ABSTRACT

A time zone of each individual network user or group of network users is identified based on clusters of a clustering algorithm (e.g., a modified K-means clustering algorithm with non-Euclidean distances). Histograms of user activity are then generated more accurately on per-time zone bases, to identify abnormal behavior. The identified behavior is tagged and notifications sent based on several behaviors or highly threatening behavior, for example.

### FIELD OF THE INVENTION

The invention relates generally to computer networking, and more specifically, to machine learning of abnormal user behavior on a network across different time zones.

### BACKGROUND

One aspect of network security is identifying anomalous behavior from users. For example, a late-night login for a user that typically only works during standard business hours could be evidence of a hacked account.

Problematically, many enterprises span across different time zones, making it difficult to determine accurately when a time zone rule has been broken. Additionally, traditional work hours of 9 to 5 are becoming less common, so hard boundaries are not accurate and do not account of individual habits. Furthermore, a large amount of use activity is timestamped, but no time zone is indicated (e.g., through VPN, or virtual private networking, masks). As a result, enterprise networks remain vulnerable to security breaches that are time dependent.

Therefore, what is needed is a robust technique for statistical detection of abnormal user behavior on a network across different time zones.

### SUMMARY

These shortcomings are addressed by the present disclosure of methods, computer program products, and systems for statistical detection of abnormal user behavior on a network across different time zones.

In one embodiment, network usage data to collect and track user activity of a plurality of users including a timestamp and activity. A time zone of each individual user is identified based on clusters of a clustering algorithm (e.g., a modified K-means clustering algorithm with non-Euclidean distances).

In another embodiment, histograms of user activity are then generated more accurately on per-time zone bases, to identify abnormal behavior. Abnormal behavior of a specific user or group of users can be based on one or more activities outside of a threshold of the generated model. The identified behavior can be tagged and notifications sent based on several behaviors or highly threatening behavior, for example.

Advantageously, both network performance and computer hardware performance are improved by preventing threats to the enterprise network.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level illustration of a system for statistical detection of abnormal user behavior on a network across different time zones, according to an embodiment.

FIG. 2 is a more detailed illustration of a UEBA server of the system of FIG. 1, according to an embodiment.

FIGS. 3A & 3B are charts showing Gaussian distributions over different time zones and resulting clustering models, according to some embodiments.

FIG. 4 is a high-level flow diagram illustrating a method for remediating abnormal user behavior on a network across different time zones, according to one preferred embodiment.

FIG. 5 is a more detailed flow diagram illustrating the step of statistical detection of abnormal user behavior on a network across different time zones for the method of FIG. 4, according to one embodiment.

FIG. 6 is an example of a computing environment, according to an embodiment.

### DETAILED DESCRIPTION

The description below provides methods, computer program products, and systems for statistical detection of abnormal user behavior on a network across different time zones. One of ordinary skill in the art will recognize many additional variations made possible by the succinct description of techniques below. For example, although K-means clustering and Gaussian functions are applied to identify time-zone based abnormal behaviors for the sake of clarity, many other machine learning and statistical models can be substituted.

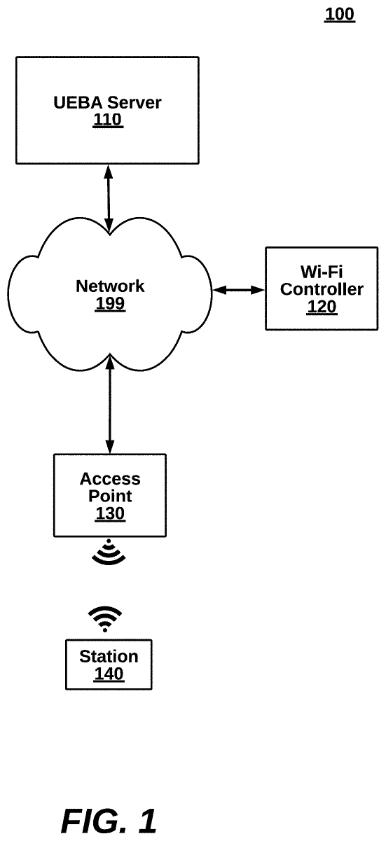

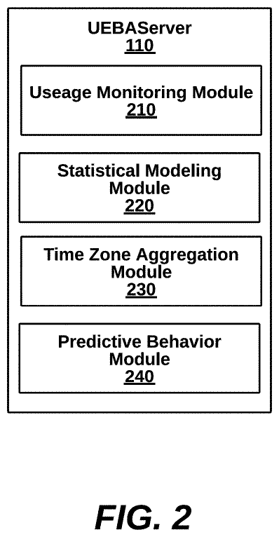

I. Systems for Abnormal Network Behavior Detection Across Different Time Zones (FIGS. 1-2)

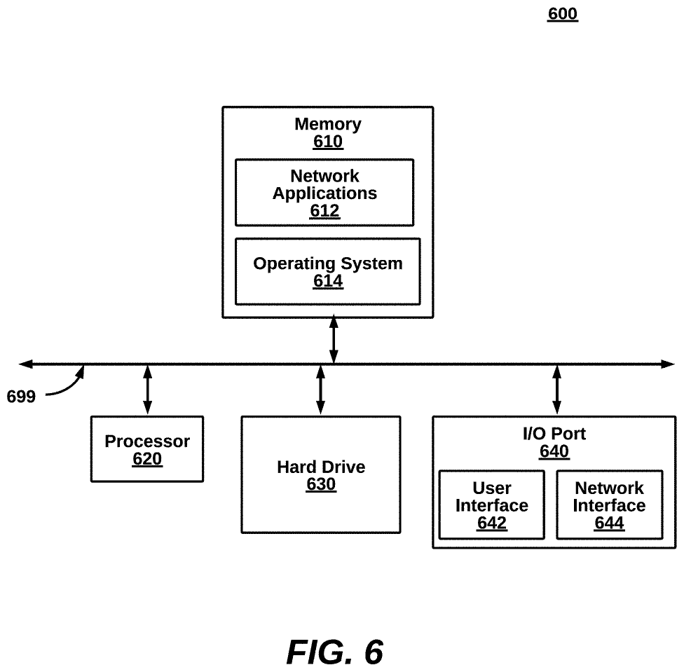

FIG. 1 is a high-level illustration of a system for statistical detection of abnormal user behavior on a network across different time zones, according to an embodiment. The system 100 includes, in part, a UEBA server 110, a Wi-Fi controller 120, an access point 130 and a station 140. Many other embodiments are possible, for example, more or fewer access points, more or fewer stations, and additional components, such as firewalls, routers and switches. The system 100 components can be located locally on a LAN or include remote cloud-based devices, and can be implemented in hardware, software, or a combination similar to the example of FIG. 6.

The components of the system 100 are coupled in communication over a network 199. Preferably, the UEBA server 110, the Wi-Fi controller 120, the access point 130 and a station 140 are connected to the data communication system via hard wire. Other components, such as the station 140 are connected indirectly via wireless connection. The network 199 can be a data communication network such as the Internet, a WAN, a LAN, WLAN, a cellular network (e.g., 3G, 4G, 5G or 6G), or a hybrid of different types of networks. Various data protocols can dictate format for the data packets.

In one embodiment, the UEBA server 110 downloads user logs from other network devices for deriving predictive models as baselines for machine learning of abnormal behavior. The usage data for pattern identification can be collected from the Wi-Fi controller 120, the access point 130 or even the station 140 can self-report usage data. Other sources can be a SIEM (security information and event management) server, a firewall or any other network device within the data path capable of logging user activity with a timestamp. In one embodiment, the usage data is automatically pushed to the UEBA server 110 and other embodiments make calls to request the usage data. The UEBA server 110 can be located within a firewall on an enterprise network or be a cloud-based SaaS (software as a service) provided to subscribers.

For identification of user time zones, user activity patterns (e.g., activity density) are tracked throughout the day rather than as individual hour-bins that track by the hour, for instance. One implementation starts with user data over 30-days in a histogram format. Data can be smoothed by convolution with a Gaussian-like function to remove the noise, making apparent a peak position and standard deviation.

Next, clustering, such as K-means clustering, can pick up time zones (e.g., 4 different time zones or less) that are discernably apart (e.g., 3 hours apart). This can be done without additional knowledge of geology, as can be imparted by an IP address. One embodiment modifies K-means clustering with a modified distance function and a modified computation of cluster center to provide better results in the present context.

For the Gaussian function, a non-Euclidean distance function, such as a Bhattacharyya distance, can be used:

d_{B}=∫\sqrt{p(x)q(x)}dx

The cluster can be an average of the distributions.

$${p}_{ave} ( t ) = \frac{1}{N} {{\sum }_{i}}^{N} {g}_{periodic} ( t ; {μ}_{i} , {σ}_{i} ) .$$

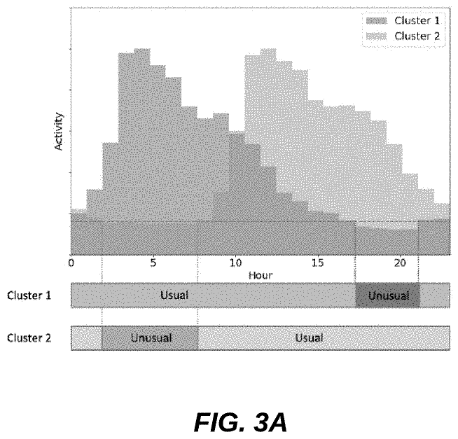

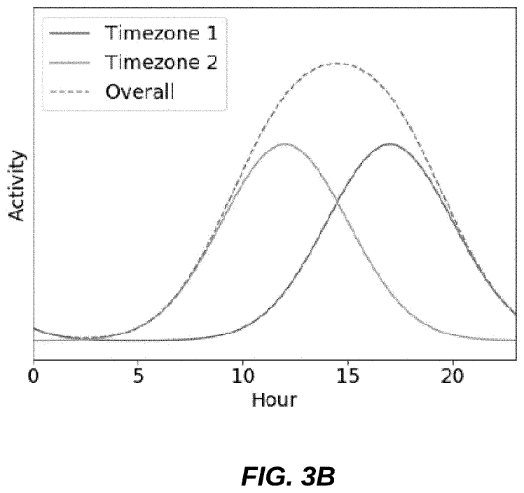

As a result, a group of users are grouped into a desired number of clusters, with each cluster being one time zone. This replaces a peer baseline of conventional methods. Instead of an activity summed for all users, the activities from users in different clusters have different histograms (see FIGS. 3A and 3B). Unusual activity can be drawn from the distinct histograms more accurately. Each user can be assigned a label for time zone and be compared against users of the label group rather than the entity as a whole.

In one embodiment, some users have activity in multiple time zones, such as when accounts are shared by multiple employees across time zones, or when a user travels to a different time zone. These accounts can be detected by projecting the user activity profile onto each cluster's center vector and thus computing a component vector of a specific user. If the maximum value of the vector units is less than 70%, the user is identified as a multi-time zone account, and a different set of policies can be applied. In one case, the multi-time zone accounts are excluded from company baselines to prevent skewed modeling.

In yet another embodiment, adaptive learning updates the learned baselines of the UEBA server 110 at regular intervals (e.g., every 24 hours). Streaming activity data, after being scrutinized by a detection engine, can be cached and fed into an adaptive training algorithm, to recompute baseline values.

The access point 130 provides wireless access for the station 140 to the backbone network with a Wi-Fi or other wireless interface and an Ethernet or other wired interface. The station 140, when within range of the access point 130, can request access to the Wi-Fi network by responding to a beacon.

FIG. 2 is a more detailed illustration of the UEBA server 110 of the system 100 of FIG. 1. The UEBA server 110 includes a usage monitoring module 210, a statistical modeling module 110, a time zone aggregation module 230, and a predictive behavior module 240.

The modules can be implemented in source code stored in non-transitory memory executed by a processor. Alternatively, the modules can be implemented in hardware with microcode. The modules can be singular, or representative of functionality spread over multiple components.

The monitoring module 210 can collect network usage data tracking user activity of a plurality of users including a timestamp and activity. A user becomes a seasoned user when enough data has been collected for a meaningful baseline. Adaptive algorithms update the baselines with updated information on a periodic bases, such as hourly, daily or monthly.

The time zone aggregation module 230 can identify a time zone of each individual user based on clustering algorithm. In one embodiment, individual users of a company are adjusted to a common reference for time zone, while another embodiment keeps users of time zones separated.

The statistical modeling module 220 generates a histogram, in an embodiment, smoothed by a Gaussian distribution. Each time zone can have a separate histogram. The user activity for a specific user is projected to a peak and a spread or standard deviation of the Gaussian distribution for each individual user.

The predictive behavior module 240 generates a predictive model using a clustering algorithm based on the adjusted aggregate Gaussian distribution. Abnormal behavior of a specific user is identified based on one or more activities outside of a threshold of the generated model. The identified behavior can be tagged and notifications sent based on several behaviors. In one case, when a new user has not yet become seasoned due to a lack of historical usage data (e.g., a cold start), behavior is analyzed solely on a comparison to a peer baseline.

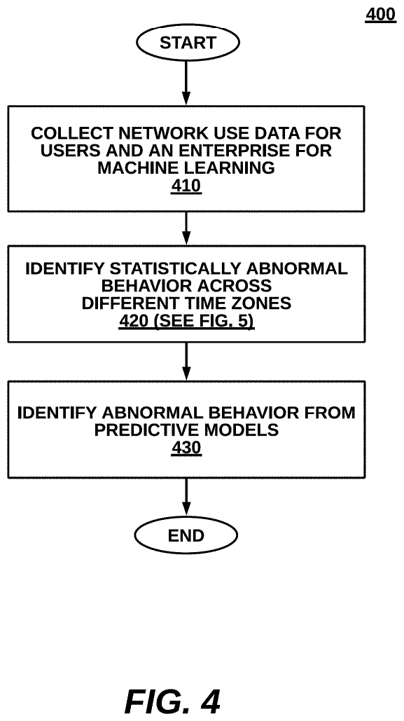

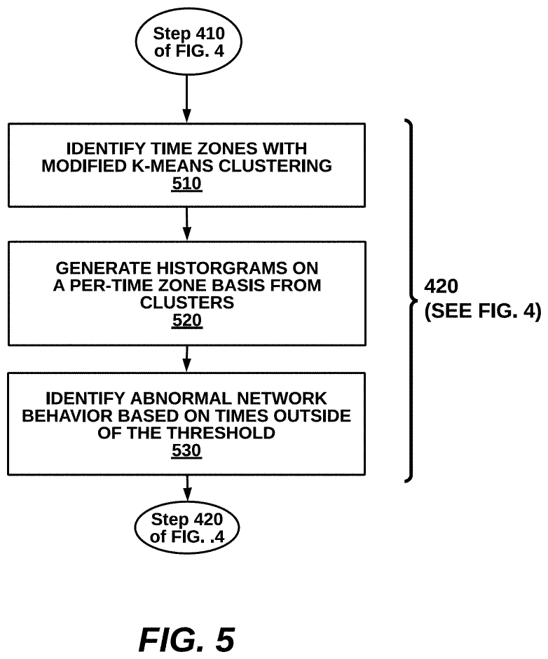

II. Methods for Abnormal Network Behavior Detection Across Times Zones (FIGS. 4-5)

FIG. 4 is a high-level flow diagram illustrating a method for remediating abnormal user behavior on a network across different time zones, according to one embodiment. The method 400 can be implemented, for example, by the system 100 of FIG. 1. The steps are merely representative groupings of functionality, as there can be more or fewer steps, and the steps can be performed in different orders. Many other variations of the method 400 are possible.

At step 410, network usage data is collected tracking user activity of individual users and enterprise use as a whole. The usage data can be sourced from a SIEM server, a Wi-Fi controller, an access point, a firewall or other device within network data paths. The usage data includes a timestamp and type of activity.

At step 420, statistically abnormal user behavior on the enterprise network is identified across different time zones. In more detail, as shown in FIG. 5 at step 510, a time zone of each individual user is identified based on clusters of a clustering algorithm. One implementation, clusters using modified K-means clustering algorithm with non-Euclidean distances. At step 520, histograms of user activity are generated on per-time zone bases, as derived from the clusters. One embodiment models histograms according to a Gaussian function. Then, at step 530, abnormal network behavior of a specific user or group of users is identified based on one or more activities outside of a threshold of the generated model.

Referring again to FIG. 4, at step 430, abnormal behavior is identified and notifications can be sent. In one embodiment, actions are automatically taken to address the abnormal behavior or resulting threat therefrom.

III. Generic Computing Device (FIG. 6)

The special processor discussed herein can operate within a computing device such as a network computing device. Other examples can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device can include a memory, a processor, a storage drive, and an I/O port. Each of the components is coupled for electronic communication via a bus. Communication can be digital and/or analog and use any suitable protocol.

The memory further comprises network applications and an operating system. The network applications 612 can include a web browser, a mobile application, an application that uses networking, a remote application executing locally, a network protocol application, a network management application, a network routing application, or the like.

The operating system can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor can be a network processor (e.g., optimized for IEEE 802.11, IEEE 802.11AC or IEEE 802.11AX), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor can be single core, multiple core, or include more than one processing elements. The processor can be disposed on silicon or any other suitable material. The processor can receive and execute instructions and data stored in the memory 610 or the storage drive.

The storage drive can be any non-volatile type of storage such as a magnetic disc, EEPROM (electronically erasable programmable read-only memory), Flash, or the like. The storage drive 630 stores code and data for applications.

The I/O port further comprises a user interface 642 and a network interface. The user interface can output to a display device and receive input from, for example, a keyboard. The network interface (e.g., RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A UEBA (user/entity behavior analysis) server coupled to an enterprise network, for statistical detection of abnormal user behavior on a network across different time zones, the network device comprising:
a processor;
a network interface communicatively coupled to the processor and to the Wi-Fi network; and
a memory, storing:
a monitoring module to collect network usage data tracking user activity of a plurality of users including a timestamp and activity;
a time zone aggregation module to identify a time zone of each individual user based on clusters of a clustering algorithm, and to generate histograms of user activity on per-time zone bases;
a statistical modeling module to model histograms of the user activity for the specific time zone;
an abnormal behavior module to identify an abnormal behavior of a specific user based on one or more activities outside of a threshold of the generated model, and to tag the identified behavior and notify based on several behaviors.

2. The UEBA server of claim 1, wherein the monitoring module receives logs of user activity from at least one of a Wi-Fi controller, an access point, a station, and a SEIM (security events and information management) server.

3. The UEBA server of claim 1, wherein the modeling module projects histograms onto a Gaussian function.

4. The UEBA server of claim 1, wherein the modeling module clusters according to K-means clustering.

5. The UEBA server of claim 1, wherein the modeling module clusters according to a modified K-means clustering, wherein a distance function and a computation of cluster center are both modified.

6. The UEBA server of claim 5, wherein the modified distance function comprises a Bhattacharyya distance.

7. The UEBA server of claim 5, wherein the modified cluster center computation comprises an average of distributions.

8. The UEBA server of claim 1, wherein the modeling module models the histograms using Gaussian functions, wherein a peak of the Gaussian represents a highest density of user activity.

9. The UEBA server of claim 1, wherein the modeling model identifies a time zone for each cluster.

10. A computer-implemented method in a UEBA (user/entity behavior analysis) server coupled to an enterprise network, for statistical detection of abnormal user behavior on a network across different time zones, the method comprising the steps of:
collecting network usage data tracking user activity of a plurality of users including a timestamp and activity;
identifying a time zone of each individual user based on clusters of a clustering algorithm;
generating histograms of user activity on per-time zone bases;
modeling histograms of the user activity for the specific time zone;
identifying an abnormal behavior of a specific user based on one or more activities outside of a threshold of the generated model; and
tagging the identified behavior.

11. A non-transitory computer-readable media in a UEBA (user/entity behavior analysis) server coupled to an enterprise network, when executed by a processor, for statistical detection of abnormal user behavior on a network across different time zones, the method comprising the steps of:
collecting network usage data tracking user activity of a plurality of users including a timestamp and activity;
identifying a time zone of each individual user based on clusters of a clustering algorithm;
generating histograms of user activity on per-time zone bases;
modeling histograms of the user activity for the specific time zone to identify;
identifying an abnormal behavior of a specific user based on one or more activities outside of a threshold of the generated model; and
tagging the identified behavior.
